(19) United States
(12) Patent Application Publication
(10) Pub. No.: US 2021/0270387 A1
(43) Pub. Date: Sep. 2, 2021

(54) METHOD OF AND APPARATUS FOR FUNCTIONALLY TESTING A PRESSURE ACTUATED REGULATOR

(71) Applicant: OXFORD FLOW LIMITED, Oxford (GB)

(72) Inventors: Benjamin Kirollos, Oxford (GB); Thomas Povey, Oxford (GB)

(21) Appl. No.: 16/645,701

(22) PCT Filed: Sep. 13, 2018
(86) PCT No.: PCT/GB2018/052610

§ 371 Date: Mar. 9, 2020

(30) Foreign Application Priority Data
Sep. 14, 2017 (GB) 1714817.2

(51) Int. Cl. F16K 37/00; G01M 3/28; G01K 13/02; F16K 1/12; G05D 16/10

(52) U.S. Cl. CPC F16K 37/0091; G01M 3/2876; G05D 16/106; F16K 1/126; G01K 13/026

(57) ABSTRACT

A method of functionally testing a pressure actuated regulator. The pressure actuated regulator includes a valve member arranged to open a valve aperture, and a control pressure volume in which a control pressure is set to act on the valve member. The method includes applying a force to the valve member, and taking measurements representative of the pressure of fluid in the control pressure volume and of the mass flow rate of the fluid into the control pressure volume while the force is being applied to the valve member. The method also includes isolating the control pressure volume and allowing a pressurised fluid in the control pressure volume to leak out of the control pressure volume, and taking measurements representative of the pressure of fluid in the control pressure volume while the fluid leaks out of the control pressure volume.

This invention relates to a method of and an apparatus for functionally testing a pressure actuated regulator, in particular to functionally testing a pressure actuated regulator to assess one or more of its operating characteristics.

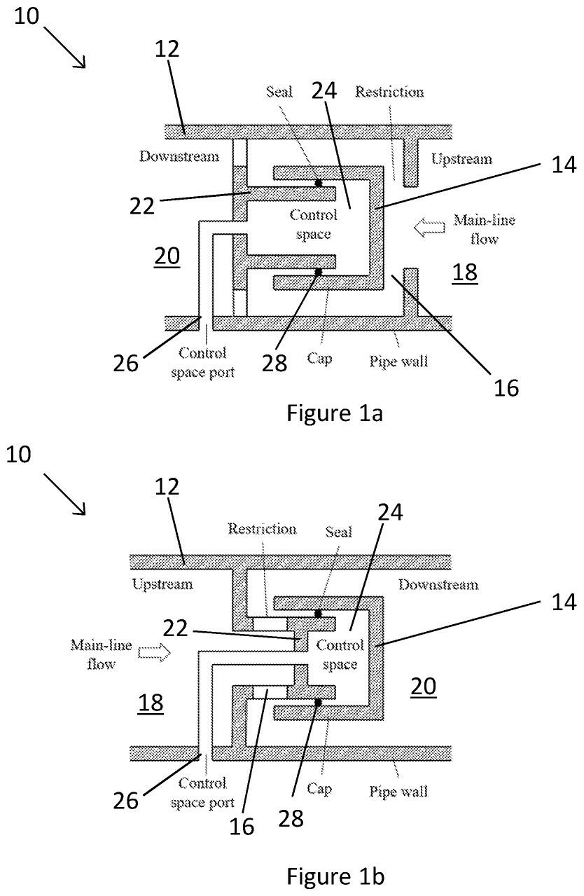

Pressure actuated regulators (such as that disclosed the Applicant's previous application WO 2013/068747 A1) may be used to control the flow of fluids in pipes and conduits, to control and stabilise the pressure of a fluid flowing therethrough. Typically, pressure actuated regulators include a moving valve member (e.g. a cap) that modulates the fluid flow through a pipe by opening and closing an aperture (a flow restriction). Two examples of such pressure actuated regulators are shown in FIGS. 1a and 1b.

In FIGS. 1a and 1b each show a pressure actuated regulator 10 for controlling the flow of fluid through a pipe 12. The pressure actuated regulator 10 includes a valve member (“cap”) 14 which opens and closes a valve aperture (“restriction”) 16 in order to control the flow of fluid from the upstream side 18 of the pipe 12 to the downstream side 20 of the pipe 12.

The valve member 14 is mounted to a housing 22 such that a control pressure volume (“control space”) 24 is defined therebetween. The control pressure volume 24 is a volume into which a control pressure can be fed (through the control port (“control space port”) 26 from an external control system, e.g. pilot regulator (not shown)) and the control pressure set. A seal 28 is provided to prevent leakage of fluid from the control pressure volume 24 into the main flow. By setting an appropriate control pressure, the main line pressure in the pipe 12 is able to be controlled because the valve member 14 will find the position where the forces on the valve member 14 (e.g. control pressure, main line pressure, friction, weight, springs if used) are balanced.

For some uses, pressure actuated regulators may operate infrequently; for example, pilot-operated pressure relief valves for emergencies may never operate, or blow-down decompression of gas compressor facilities for planned maintenance may operate only a limited number (e.g. up to five times) per annum. In these scenarios, periodically checking the operation of the pressure actuated regulator may be required to satisfy maintenance and operational requirements. Even for applications where the pressure actuated regulator is operated frequently, it may be necessary to perform regular check-ups of the regulator to inform maintenance scheduling and to flag potential problems.

Thus it is an object of the invention to provide a method of functionally testing a pressure actuated regulator.

When viewed from a first aspect the invention provides a method of functionally testing a pressure actuated regulator, wherein the pressure actuated regulator comprises a valve member arranged to open and close one or more valve apertures, and a control pressure volume in which a control pressure is set to act on the valve member, the method comprising:

applying a force to the valve member, and taking measurements representative of the pressure of fluid in the control pressure volume and of the mass flow rate of the fluid into the control pressure volume while the force is being applied to the valve member;

isolating the control pressure volume and allowing a pressurised fluid in the control pressure volume to leak out of the control pressure volume, and taking measurements representative of the pressure of fluid in the control pressure volume while the fluid leaks out of the control pressure volume; and

communicating and/or storing, for assessing one or more operating characteristics of the pressure actuated regulator, the measurements taken representative of the pressure of fluid in the control pressure volume and of the mass flow rate of the fluid into the control pressure volume while the force was being applied to the valve member, and the measurements taken representative of the pressure of fluid in the control pressure volume while the control pressure was leaking out of the control pressure volume.

When viewed from a second aspect the invention provides an apparatus for functionally testing a pressure actuated regulator, wherein the pressure actuated regulator comprises a valve member arranged to open and close one or more valve apertures, and a control pressure volume in which a control pressure is set to act on the valve member, the apparatus comprising:

one or more isolation valves for isolating the control pressure volume;

a pressure sensor for measuring a pressure representative of the pressure of fluid in the control pressure volume;

a flow rate sensor for measuring a mass flow rate of fluid into the control pressure volume; and

a communication subsystem and/or a data storage for communicating and/or storing the measurements representative of the pressure and temperature of fluid in the control pressure volume;

wherein the apparatus is configured to:
take measurements representative of the pressure of fluid in the control pressure volume using the pressure sensor and of the mass flow rate of fluid into the control pressure volume using the flow rate sensor while a force is being applied to the valve member;
close the one or more isolation valves to isolate the control pressure volume;
allow a pressurised fluid in the control pressure volume to leak out of the control pressure volume, and take measurements representative of the pressure of fluid in the control pressure volume using the pressure sensor while the fluid leaks out of the control pressure volume; and
communicate and/or store, for assessing one or more operating characteristics of the pressure actuated regulator, the measurements taken representative of the pressure of fluid in the control pressure volume and of the mass flow rate of the fluid into the control pressure volume while the force was being applied to the valve member, and the measurements taken representative of the pressure of fluid in the control pressure volume while the control pressure was leaking out of the control pressure volume.

The present invention provides a method of and an apparatus for functionally testing a pressure actuated regulator. The pressure actuated regulator includes a control pressure volume that contains a control pressure which is set and used to act on the valve member of the pressure actuated regulator to open and close one or more valve apertures, i.e. to control the flow of fluid through the pressure actuated regulator (from an upstream side of the regulator to a downstream side of the regulator).

The method of the present invention involves applying a force on the valve member and (e.g. then) allowing a pressurised fluid in the control pressure volume to leak out (e.g. into the mainline pipe or conduit, e.g. through a seal) by isolating the control pressure volume. During both of these steps, one or more measurements that are representative of the pressure of the fluid in the control pressure volume are taken, and during the step of applying a force to the valve member one or more measurements of the mass flow rate of fluid into the control volume are taken. These measurements are then communicated and/or stored so that one or more operating characteristics of the pressure actuated regulator may be assessed.

The apparatus of the present invention (for functionally testing a pressure actuated regulator) includes one or more isolation valves arranged to isolate the control pressure volume (to allow the pressurised fluid in the control pressure volume to leak out of the control pressure volume). The apparatus also includes pressure and flow rate sensors, and a communication subsystem and/or a data storage for communicating and/or storing the pressure and mass flow rate measurements. The various components of the apparatus are configured to perform the various steps according to the method of the present invention.

Thus it will be appreciated that the method and test apparatus of the present invention enables a simple and repeatable test procedure to be performed on a pressure actuated regulator such that it can be checked how well the pressure actuated regulator is performing (e.g. a “health check”). Owing to a test apparatus being used, this helps the test procedure to avoid being subject to user error.

Furthermore, because the test procedure involves manipulating the control pressure volume only of a pressure actuated regulator, this (preferably) does not involve passing fluid through the regulator itself. Thus the method may be performed and the apparatus used on the pressure actuated regulator non-intrusively. However, the method and apparatus may enable a number of operating characteristics (e.g. pressure operating, friction and opening characteristics) of the pressure actuated regulator to be assessed, owing to the measurements that are taken.

The functional testing of the method and by the apparatus of the present invention may also verify that the valve member of the pressure actuated regulator opens and closes fully (e.g. before and after the step of applying a force to the valve member), may quantify the integrity of a seal between the control pressure volume and the main line in which the regulator is located (e.g. using the measurements taken during the leakage step), and may quantify the frictional properties of the valve member (e.g. using the measurements taken during the step of applying a force to the valve member).

It will further be appreciated that the functional testing of the method and by the apparatus of the present invention may not require the main line of the pipe or conduit in which the pressure actuated regulator is positioned to be broken or even for an inspection port to be opened. This is because the test procedure may be able to be (and in a preferred embodiment it is) performed simply by attaching the test apparatus to (e.g. a control port of) the control pressure volume, e.g. to which a control system for introducing a control pressure into the control pressure volume may be attached during normal operating of the pressure actuated regulator. The control port of the control pressure volume may be (and preferably is) accessible externally (e.g. of the regulator and of the pipework (the main line) in which the regulator is located).

As well as preferably not having to open the main line in which the pressure actuated regulator is located, the main line may not be (and preferably is not) required to be pressurised while the test procedure is performed; again, owing to the testing being performed on the control pressure volume. This helps to simplify the test procedure.

The method and the apparatus of the present invention may be used to functionally test any suitable and desired type of pressure actuated regulator containing a control pressure volume (e.g. as shown schematically in FIGS. 1a and 1b) which acts on a valve member to control the flow of fluid through the regulator. Thus preferably the pressure actuated regulator is mounted in a (“main line”) pipe or conduit. The pressure actuated regulator may comprise a biasing member (e.g. a spring) arranged to act (e.g. apply a force) on the valve member (i.e. in addition to the control pressure in the control pressure volume). The biasing member may be used to control the operating characteristics of the pressure actuated regulator and/or may help to close the valve aperture(s) when there is little or no flow in the main line through the pressure actuated regulator. Preferably the biasing member is provided in the control pressure volume, i.e. preferably the control pressure volume comprises the biasing member.

Preferably the pressure actuated regulator comprises a seal between the control pressure volume and the valve member. This helps to substantially seal the control pressure volume. However, as will be appreciated, some (e.g. a small amount of) leakage may still occur from the control pressure volume past the seal (and it is this leakage which is determined to determine, in preferred embodiments, the integrity of the seal).

Preferably the pressure actuated regulator comprises a control port for introducing a control pressure into the control pressure volume; thus preferably the control port is fluidically connected to the control pressure volume. Preferably the control port is accessible externally (e.g. to the pressure actuated regulator and, e.g., to the main line (pipe or conduit) in which the regulator is installed).

Preferably the pressure actuated regulator comprises a control system connected to the control pressure volume (during normal operation of the regulator), e.g. via the control port, wherein the control system is arranged to set the control pressure in the control pressure volume.

The control system may be provided in any suitable and desired way, e.g. depending on the type of the pressure actuated regulator being tested. Thus the control system may comprise one or more of: one or more pilot valves, one or more pumps, one or more springs, one or more orifices, one or more venturi nozzles, one or more filters, one or more vents, computerised automation, telemetry, etc. The control system may be fed by, and/or eject into, the main fluid line (e.g. pipe or conduit in which the regulator is located), though this may not always be the case.

It will thus be appreciated that the method and the apparatus of the present invention are not specific to any particular type of pressure actuated regulator or control system that may be used to control the regulator. The regulator simply needs to be pressure actuated, i.e. to have a control pressure volume that is pressurised (and the pressure of which is controlled) to enact a restriction and/or derestriction of the fluid flow via a moving valve member. It will also be appreciated that the specifics of the method and the apparatus of the present invention may vary depending on the particular type of pressure actuated regulator being tested (e.g. owing to its pressure range, its operating mechanism and/or whether it comprises a biasing member or not).

So that the method and the apparatus of the present invention may be used, preferably the method comprises disconnecting the (e.g. external) control system from the (e.g. control port of the) control pressure volume of the pressure actuated regulator to be tested, e.g. after checking that it is safe to do so. This then allows the apparatus of the present invention to be connected to the pressure actuated regulator so that the test procedure may be performed. Thus preferably the method comprises connecting the apparatus of the present invention to the (e.g. control port of the) control pressure volume of the pressure actuated regulator to be tested. Preferably the apparatus comprises an output port for attaching the apparatus to the (e.g. control port of the) control pressure volume)

The step of applying a force to the valve member (and taking the appropriate pressure and mass flow rate measurements) may be performed starting from any suitable and desired starting (e.g. steady state) pressure of the control pressure volume, e.g. with the valve member in a neutral position. The force may be applied to the valve member in any suitable and desired direction, e.g. to open or close the valve member (i.e. to maximise or minimise the control pressure volume, which may open or close the valve aperture(s), or vice versa depending on the configuration of the pressure actuated regulator). However preferably the control pressure volume is depressurised first to (e.g. fully or substantially) close the valve member (i.e. to minimise the control pressure volume). This helps to assess the closed position of the valve member and helps to maximise the distance through which the valve member travels during the test procedure.

Thus preferably the method comprises (and the apparatus comprises a depressurisation subsystem for) depressurising the control pressure volume, e.g. to substantially close the valve member (i.e. in a position in which the volume of the control pressure volume is at a minimum). Thus preferably the apparatus is configured to depressurise the control pressure volume using the depressurisation subsystem.

Depressurising the control pressure volume moves (e.g. sucks) the valve member into its nominally closed position. The control pressure volume may be depressurised in any suitable and desired way. Preferably the depressurisation subsystem comprises a vacuum line arranged to depressurise the control pressure volume. Thus preferably the control pressure volume is depressurised to substantially a vacuum (this may be below the pressure required to fully close the valve member).

Preferably the method comprises (and the apparatus is configured to, using the respective sensors) taking (e.g. a plurality of respective) measurements representative of the pressure (and, e.g., temperature) of fluid in the control pressure volume and of the mass flow rate of the fluid out of the control pressure volume while the control pressure volume is being depressurised.

Preferably the control pressure volume is depressurised before the force is then applied to the valve member.

The force may be applied to the valve member in any suitable and desired way. Preferably the force is applied to move the valve member to increase the volume of the control pressure volume (e.g. from a minimum volume to a maximum volume).

In the embodiments in which the pressure actuated regulator comprises a biasing member (e.g. a spring) arranged to act on the valve member, preferably the biasing member is arranged to apply the force to the valve member, e.g. to move the valve member to increase the volume of the control pressure volume. In these embodiments preferably the control pressure volume is filled from atmosphere (e.g. through a vent, e.g. in the apparatus) as the valve member is moved under the action of the biasing member to increase the volume of the control pressure volume.

Thus preferably the apparatus comprises a vent for allowing the control pressure volume to fill from atmosphere. Preferably the vent is closed while the control pressure volume is depressurised and preferably (e.g. then) opened to allow the control pressure volume to be filled from atmosphere.

Preferably the control pressure volume is filled through the apparatus, e.g. through the flow rate sensor. Preferably the apparatus comprises a restriction through which fluid is arranged to flow while the control pressure volume is filled from atmosphere. Such a restriction (which may, e.g., form part of the flow rate sensor) helps to control the rate of flow of fluid into the control pressure volume. The size of the restriction may be chosen to be any suitable and desired size, e.g. to maintain the flow of fluid into the control pressure volume at a constant rate, and the restriction may comprises a variable restriction, e.g. a needle valve.

Preferably the method comprises (and the apparatus is configured to close the one or more isolation valves to) isolating the control pressure volume (e.g. after the control pressure volume has been depressurised and, e.g., before the force is applied to the valve member).

In a preferred set of embodiments (in which the pressure actuated regulator may or may not comprise a biasing member) the force is applied to the valve member by pressurising the control pressure volume. Thus preferably the apparatus comprises a pressurisation subsystem for pressurising the control pressure volume and the method comprises pressurising the control pressure volume (using the pressurisation subsystem). Thus in these embodiments the control pressure volume is actively pressurised to move the valve member (e.g. from a closed position to an open position), rather than allowing a biasing member to act on the valve member, for example.

The control pressure volume may be pressurised in any suitable and desired way using the pressurisation subsystem (which is preferably in fluid communication with the output port of the apparatus). In one embodiment the pressurisation subsystem of the apparatus comprises a source of pressurised fluid, e.g. a pressurised gas (e.g. nitrogen) cylinder, arranged to feed pressure into the control pressure volume. Preferably the rate at which the control pressure volume is pressurised is controlled (e.g. set), e.g. preferably the pressurisation subsystem comprises a pressure regulating valve (e.g. that is fluidically connected to and, e.g., controls (e.g. sets) the rate at which the control pressure volume is pressurised).

In one embodiment the flow rate of fluid into the control pressure volume while the control pressure volume is being pressurised is maintained at a substantially constant flow rate. Preferably the pressurisation subsystem of the apparatus comprises restriction for choking the flow of fluid into the control pressure volume of the pressure actuated regulator. The restriction may be provided as well as or instead of the pressure regulating valve (e.g. the restriction may control the flow rate and the pressure regulating valve may control the rate at which the control pressure volume is pressurised).

When the apparatus comprises a depressurisation subsystem preferably the apparatus is arranged to switch between the depressurisation subsystem and the pressurisation subsystem being connected to the control pressure volume (e.g. via the output port of the apparatus). Thus preferably the apparatus comprises one or more valves for switching between the depressurisation subsystem and the pressurisation subsystem being connected to the control pressure volume.

It will be appreciated that in an initial phase of the force being applied to the valve member (e.g. the control pressure volume being pressurised or the biasing member acting on the valve member), the control pressure volume may be being filled or pressurised but the valve member is yet to move (e.g. from its nominal closed position), e.g. owing to insufficient pressure in the control pressure volume. In a second phase (e.g. of the control pressure volume being pressurised), the valve member starts to move, e.g. the pressure in the control pressure volume reaches a level sufficient to move the valve member. In a third phase (e.g. of the control pressure volume being pressurised), the valve member has been opened fully (i.e. the control pressure volume is at its maximum volume), and thus the control pressure volume may be pressurised further while the valve member is not able to move any further.

(It will be appreciated that the pressure in the control pressure volume may not increase for the whole of the time during which the force is acting on the valve member, e.g. during the pressurising step. For example, if the valve member starts in a nominally closed position, the pressure in the control pressure volume may increase initially while the valve member is closed (e.g. in the initial phase) until the valve member starts to move, at which point (e.g. during the second phase) the pressure in the control pressure volume may decrease slightly and then stabilise before increasing again as the valve member moves towards its open position.)

These phases (e.g. of the pressurisation) of the control pressure volume (e.g. defined by the position and dynamics of the valve member) help to enable the (e.g. extreme) position(s) of the valve member and the friction of the valve member (e.g. the friction between the valve member and the stationary parts (e.g. housing) of the pressure actuated regulator) to be assessed (e.g. quantified) using the pressure and mass flow rate measurements that are taken.

The measurements representative of the pressure and mass flow rate taken while the force is being applied to the valve member (e.g. while the control pressure volume is being pressurised) may be a single measurement of the pressure and a single measurement of the mass flow rate during this period. However, preferably a plurality of measurements of each of the pressure and the mass flow rate are taken (e.g. while the force is being applied to the valve member). This enables, for example, measurements to be taken during each of the phases of the valve member being static (e.g. when the valve member is closed and the control pressure volume is at a minimum), moving and reaching its end point (e.g. when the valve member is open and the control pressure volume is at a maximum), which helps to assess the performance of the pressure actuated regulator better.

In this embodiment the plurality of measurements may be taken in any suitable and desired way. For example, the pressure and the mass flow rate may be measured continuously while the force is being applied to the valve member (e.g. while the control pressure volume is being pressurised). Alternatively, a plurality of discrete measurements (e.g. taken (e.g. automatically) at a particular frequency) may be taken.

In one embodiment, the control pressure volume is pressurised a plurality of times, e.g. at a plurality of different rates of pressurisation. Thus preferably the method comprises (and the pressurisation subsystem is arranged to) pressurising the control pressure volume a plurality of (e.g. approximately five) times at different rates of pressurisation. Preferably the pressure (and, e.g., temperature) representative of the pressure (and, e.g., temperature) of fluid in the control pressure volume and of the mass flow rate of fluid into the control pressure volume are measured (e.g. a plurality of times) at each different rate of pressurisation. This may enable the friction to be determined as a function of the velocity of the valve member.

Preferably the different rates of pressurisation are set by adjusting the pressure provided by the pressurisation subsystem, e.g. by the pressure regulating valve. Preferably the control pressure volume is depressurised between each of the plurality of pressurisations.

The force may be applied to the valve member for any suitable and desired period of time, e.g. the control pressure volume may be pressurised to any suitable and desired pressure. Preferably the force is applied to the valve member (e.g. the control pressure volume is pressurised) until at least the control pressure volume reaches a maximum volume (i.e. when the valve member is fully open, e.g. when the one or more valve apertures are fully closed by the valve member). When the control pressure volume has reached its maximum volume (owing to the force being applied to the valve member), preferably the force is continued to be applied to the valve member (e.g. preferably the control pressure volume is continued to be pressurised, e.g. at a steady rate). This helps to assess the maximum volume of the control pressure volume (and thus the maximum open position of the valve member).

Preferably the control pressure volume is pressurised to the maximum rated pressure of the pressure actuated regulator or to the maximum pressure able to be delivered by the test pressurisation subsystem of the apparatus (whichever is the lower). Both of these maximum pressures are preferably greater than the pressure of the control pressure volume when the control pressure volume has been increased to its maximum volume. Increasing the control pressure to such a pressure (i.e. larger than is required to move the valve member such that the control pressure volume reaches its maximum volume) helps to enable the maximum volume of the control pressure volume to be determined, e.g. because this provides a tolerance that helps to ensure that the control pressure volume has reached its maximum. When the step of allowing the pressurised fluid to leak out of the control pressure volume follows (e.g. straight) after the step of the force being applied to the valve member (which, in some embodiments, is not the case), increasing the control pressure to such a pressure allows the fluid in the control pressure volume to leak out over a large range of pressures, thus helping to assess the leakage mass flow rate out of the control pressure volume (e.g. past the seal), in the embodiments in which the control pressure volume is pressurised before allowing the fluid to leak out of the control pressure volume.

Preferably the control pressure volume is pressurised at a faster rate after the control pressure volume has reached its maximum volume than before the control pressure volume has reached its maximum volume (and preferably also after the force is continued to be applied to the valve member after the control pressure volume has reached its maximum volume, in the embodiments in which this happens). This is because once the control pressure volume has reached its maximum volume, the valve member is static and so the measurements that may be taken during this time may be of less interest.

Another part of the test procedure, e.g. following the pressurisation of the control pressure volume, is to allow the pressurised fluid (e.g. control pressure) in the control pressure volume to leak out of the control pressure volume, by isolating the control pressure volume (by closing the one or more isolation valves in the apparatus, e.g. to close the control port into the control pressure volume). Thus preferably the pressurised fluid that is allowed to leak out of the control pressure volume in this step is the pressurised fluid that has been introduced into the control pressure volume during the pressurisation step. By taking pressure (and, e.g., temperature) measurements while the pressurised fluid leaks out of the control pressure volume (e.g. after an initial settling period, after which the control pressure decays owing to the leakage), the leakage mass flow rate (e.g. at different pressures) may be determined, which helps to assess the integrity of the (e.g. seal of the) control pressure volume.

Thus, when the pressure actuated regulator comprises a biasing member, preferably the control pressure volume is pressurised (e.g. using the pressurisation subsystem) after the biasing member has (at least partially) moved the valve member, e.g. to its fully open position. This helps to increase the pressure in the control pressure volume above the main line pressure, so that a pressurised fluid may be allowed to leak out of the control pressure volume and the leakage of fluid from the control pressure volume may be assessed.

While the leakage may be assessed using just the pressure measurements that are taken while the pressurised fluid leaks out of the control pressure volume, preferably measurements representative of the temperature of the fluid in the control pressure volume are taken while the fluid leaks out of the control pressure volume. (As will be described below, preferably the mass flow rate out of the control pressure volume owing to leakage (e.g. round a seal) is determined using these pressure (and, e.g., temperature) measurements.)

Preferably the pressurised fluid in the control pressure volume is allowed to leak out of the control pressure volume while the valve member is in a known (e.g. fixed and thus stationary) position. This helps in the assessment of the leakage from the control pressure volume owing to the known volume of the control pressure volume (as well as the volume of the pipework between the control pressure volume and the one or more isolation valves). Preferably the pressurised fluid in the control pressure volume is allowed to leak out of the control pressure volume while the valve member is in its open position (i.e. when the volume of the control pressure volume is at its maximum).

The measurements representative of the pressure (and, e.g., temperature) taken while the fluid is leaking out of the control pressure volume may be a single measurement of the pressure (and, e.g. a single measurement of the temperature) during this period. However, preferably a plurality of measurements representative of (e.g. each of) the pressure (and, e.g., the temperature) are taken while the fluid is leaking out of the control pressure volume. This enables, for example, measurements to be taken at a range of different pressures (e.g. pressure ratios (e.g. between the control pressure and the pressure in the main line the other side of the valve member)) while the pressurised fluid leaks out of the control pressure volume, which helps to assess the performance of the pressure actuated regulator better.

If the pressure ratio is used as the independent variable for assessing the leakage mass flow rate from the control pressure volume, preferably the method comprises taking a measurement representative of the pressure in the main line of the pressure actuated regulator (and the apparatus comprises a pressure sensor for measuring this pressure). This may be necessary particularly when the main line pressure is not atmospheric pressure.

The plurality of measurements may be taken in any suitable and desired way. For example, the measurements representative of the pressure (and, e.g., the temperature) may be measured continuously while the control pressure volume is being pressurised. Alternatively, a plurality of discrete measurements (e.g. taken (e.g. automatically) at a particular frequency) may be taken.

The pressurised fluid (e.g. control pressure) in the control pressure volume could be allowed to simply leak away until equilibrium (e.g. with the pressure in the main line) has been reached (and, e.g., a plurality of pressure representative (and, e.g., temperature) measurements taken at a plurality of different control pressures). However, this may take a long period of time. Therefore in a preferred embodiment the method comprises (and the isolation valves are opened to) venting the control pressure volume (e.g. after the fluid in the control pressure volume has been leaking out of the control pressure volume for a period of time, e.g. before the control pressure reaches equilibrium). Preferably the control pressure volume is vented (e.g. through the control port and) back into the apparatus connected to the control pressure volume. Thus preferably the apparatus comprises one or more vents for venting the control pressure volume. In another embodiment the control pressure volume could be pressurised (using the pressurisation subsystem) to a (or, e.g., successive) higher pressure(s) from which the pressurised fluid is allowed to leak out of the pressure control volume.

Preferably, after the control pressure volume has been vented (or further pressurised), the control pressure volume is (again) isolated (i.e. by closing the one or more isolation valves) and the fluid in the control pressure volume is allowed to leak out of the control pressure volume, and measurements representative of the pressure (and, e.g., temperature) of fluid in the control pressure volume are taken while the fluid leaks out of the control pressure volume. It will be appreciated that this allows the measurements to be taken at a different control pressure.

In a preferred embodiment the control pressure volume is vented a plurality of times and preferably after each venting of the control pressure volume, the pressure (and, e.g., temperature) representative measurements are taken, as outlined above. This enables a plurality of pressure (and, e.g., temperature) representative measurements to be taken over a range of control pressures, over a relatively short period of time.

Preferably this process of venting (or further pressurising), (e.g. allowing the control pressure to settle) and allowing the fluid to leak out of the control pressure volume is repeated (e.g. by opening and closing the one or more isolation valves) until the control pressure reaches equilibrium (or until the desired number of measurements have been taken). Thus the control pressure volume may be vented (or further pressurised) any suitable and desired number of times, e.g. depending on how long it takes until the control pressure has reduced to equilibrium. Preferably the pressure (and, e.g., temperature) measurements are taken continuously during the repeated venting (or further pressurising) and leaking of the control pressure from the control pressure volume.

The (e.g. each) period of time over which the fluid is allowed to leak out of the control pressure volume may be any suitable and desired period of time. In a preferred embodiment the (e.g. each) period of time is greater than 30 seconds, e.g. greater than 60 seconds, e.g. greater than 100 seconds, e.g. greater than 200 seconds.

In one embodiment the apparatus comprises a dead volume arranged between the control pressure volume and the one or more isolation valves. The dead volume in the apparatus preferably has a greater volume than the volume of the control pressure volume, e.g. approximately twenty times greater. The dead volume increases the combined volume of the control pressure volume and the dead volume and helps to make the assessment of the leakage from the control pressure volume less dependent on the (e.g. potentially unknown) volume of the control pressure volume and more dependent on the known volume of the dead volume in the apparatus.

When the apparatus comprises a dead volume, preferably the dead volume comprises an isolation valve, to allow the dead volume to be opened (i.e. to be put into fluid communication with the control pressure volume for use in assessing the leakage from the control pressure volume) and closed (i.e. to be removed from fluid communication with the control pressure volume, e.g. for the step of applying a force to the valve member). In order to assess the leakage from the control pressure volume, preferably the dead volume is pressurised with the control pressure volume (and preferably the pressures therein are allowed to stabilise before the leakage is assessed).

As well as taking measurements representative of the pressure of the fluid in the control pressure volume and (during the leakage step of the test) of the mass flow rate of fluid into the control pressure volume, any other suitable and desired measurements may be taken, e.g. for assessing one or more operating characteristics of the pressure actuated regulator. As alluded to above, in a preferred embodiment the method comprises (and the apparatus comprises a temperature sensor for measuring a temperature representative of the temperature of fluid in the control pressure volume) taking a measurement representative of the temperature of fluid in the control pressure volume while the control pressure volume is being pressurised and while the fluid is allowed to leak out of the control pressure volume. The representative temperature of the fluid in control pressure volume may (e.g. also or instead) be measured (or inferred) by measuring the ambient temperature, e.g. in the main line or externally to the pressure actuated regulator.

The skilled person will appreciate that all the optional and preferred features relating to the pressure and mass flow rate representative measurements apply equally to the temperature representative measurement (e.g. taking a plurality of such measurements, e.g. continuously). Thus preferably the method comprises (and the communication subsystem and/or data storage is configured to) communicating and/or storing, for assessing one or more operating characteristics of the pressure actuated regulator, the measurement(s) taken representative of the temperature in the control pressure volume while the control pressure volume was being pressurised, and the measurement(s) taken representative of the temperature in the control pressure volume while the control pressure was leaking out of the control pressure volume.

Although the various steps of the method may be performed (e.g. by the apparatus of the present invention) in any suitable and desired order and at any suitable and desired time, preferably the steps are performed in the order outlined in the method and are performed one after each other (e.g. contiguously in time). However, it will be appreciated that this is not necessary and the various steps of the method may be performed at different times (e.g. with one or more steps separated by a period of time) rather than performing a continuous test.

Preferably the method is performed automatically (e.g. by the apparatus of the present invention), e.g. by (the apparatus) automatically depressurising, applying a force to the valve member (e.g. pressurising) and/or allowing the fluid to leak out of the control pressure volume, as appropriate.

The apparatus may be provided in any suitable and desired way, e.g. as outlined above for the different subsystems. The pressure, flow rate and, e.g. temperature, sensors may comprise any suitable and desired sensors for taking the respective temperature and pressure representative measurements. In a preferred embodiment the temperature sensor comprises a (e.g. electronic) temperature transducer and/or the pressure sensor comprises a (e.g. electronic) pressure transducer. Preferably the temperature, flow rate and/or pressure sensors are arranged to take the respective temperature, mass flow rate and pressure representative measurements automatically.

Preferably the pressure, flow rate and/or, e.g. temperature, sensors are (e.g. electrically) connected to the communication subsystem and/or the data storage. This helps to communicate and/or store the measurements, e.g. automatically, that have been taken. Preferably the apparatus comprises a data acquisition subsystem arranged to acquire (e.g. receive) the measurements taken from the respective sensors. Preferably the data acquisition subsystem is connected to the pressure, flow rate and/or, e.g. temperature, sensors (and any other sensors the apparatus may comprise) and/or connected to the communication subsystem and/or the data storage. Preferably the data acquisition subsystem comprises the communication subsystem and/or the data storage.

In order to take measurements that are representative of the pressure (and, e.g., temperature) of the fluid in the control pressure volume, preferably the pressure (and, e.g. temperature) sensor(s) are positioned in the apparatus as close to the control pressure volume as possible (e.g. when the apparatus is connected to the control pressure volume). Thus preferably the pressure and/or temperature sensors are positioned as close as possible to the control port of the pressure actuated regulator, e.g. as close as possible to the output port of the apparatus (which connects to the control port of the pressure actuated regulator).

As well as the one or more isolation valves for isolating the control pressure volume, the apparatus may comprise one or more other valves, e.g. for connecting the various components and/or subsystems of the apparatus. The one or more other valves may be arranged to switch the various components and/or subsystems of the apparatus into and out of use (e.g. to connect them to or disconnect them from the control pressure volume of the pressure actuated regulator, e.g. via the control port of the control pressure volume and the output port of the apparatus).

The flow rate sensor may comprise any suitable and desired flow rate sensor for measuring the mass flow rate of the fluid into the control pressure volume of the pressure actuated regulator. In a preferred embodiment the flow rate sensor comprises an orifice (e.g. plate), a venturi (e.g. nozzle) or an ultrasonic flow meter.

The orifice (for generating a choked flow of fluid therethrough) may be provided in any suitable and desired way. A needle valve (e.g. to function as a variable orifice) may be provided instead of an orifice or a plurality of (e.g. calibrated) orifices (e.g. in parallel with each other). One of the plurality of orifices may be selected (e.g. using a plurality of isolation valves) for the appropriate pressurisation (or depressurisation) of the control pressure volume.

The flow rate sensor may be provided in any suitable and desired position in the apparatus for measuring the mass flow rate of fluid into the control pressure volume. In a preferred embodiment the flow rate sensor is provided in a length of (e.g. undisturbed) conduit. Preferably the conduit is has a length of at least ten (e.g. twenty) times the diameter of the conduit upstream and/or downstream of the flow rate sensor.

Preferably the apparatus comprises one or more conduits connecting the various components and/or subsystems of the apparatus. Preferably the apparatus comprises a safety valve (e.g. vent) to allow for redundant venting options.

Thus preferably the apparatus comprises a (e.g. electronic) control subsystem arranged to control (e.g. automatic) operation of the test procedure. Thus preferably the control subsystem (which may comprise the data acquisition subsystem) is arranged to operate one or more of: the pressurisation subsystem, the depressurisation subsystem, the one or more isolation valves, the communication subsystem, the data storage, the data acquisition subsystem and/or any other components (e.g. valves and vents) that the apparatus comprises. Preferably the control subsystem is arranged to actuate one or more valves to bring the one or more subsystems (and other components) into and out of operation.

Once all of the measurements have been taken, the measurements are communicated (from the apparatus by the communication subsystem) and/or stored (by the data storage) for assessing (e.g. at a later time) one or more operating characteristics of the pressure actuated regulator, e.g. the position(s) of the valve member, the friction between the valve member and the other (e.g. stationary) parts of the pressure actuated regulator, and/or the leakage mass flow rate from the control pressure volume (e.g. through the seal).

The apparatus may comprise a data processor for assessing the one or more operating characteristics of the pressure actuated regulator. In a preferred embodiment the measurements are communicated from the apparatus and/or the measurements are stored for processing the measurements using a remote data processor (e.g. computer), e.g. after the measurements have been taken.

The one or more operating characteristics of the pressure actuated regulator may be determined, from the measurements that have been taken, in any suitable and desired way. In a preferred embodiment a dynamic model of the system may be used to determine the one or more operating characteristics of the pressure actuated regulator. The dynamic model preferably takes into account the structural characteristics of the pressure actuated regulator that are known. The dynamic model is preferably adjusted to account for forces that act on the valve member, e.g. owing to a biasing member.

In a preferred embodiment the one or more operating characteristics of the pressure actuated regulator that may be determined include one or more of: verification of the fully open and the fully closed positions of the valve member, the integrity of the seal of the control pressure volume, and the static and the dynamic friction of the valve member.

This is considered to be novel and inventive in its own right and thus when viewed from a further aspect the invention provides a method of determining a plurality of operating characteristics of a pressure actuated regulator, wherein the pressure actuated regulator comprises a valve member arranged to open and close one or more valve apertures, and a control pressure volume in which a control pressure is set to act on the valve member, the method comprising:

determining the maximum and minimum positions of the valve member, using measurements representative of the pressure of fluid in the control pressure volume and of the mass flow rate of the fluid into the control pressure volume taken while a force was being applied to the valve member;

determining the leakage out of the control pressure volume, using measurements representative of the pressure of fluid in the control pressure volume taken while a pressurised fluid was leaking out of the control pressure volume; and

determining the friction on the valve member, using measurements representative of the pressure of fluid in the control pressure volume and of the mass flow rate of the fluid into the control pressure volume taken while the force was being applied to the valve member.

It will be appreciated that this aspect of the invention may (and preferably does) include one or more of the optional and preferred features discussed herein. For example, measurements representative of a temperature of the fluid in the control pressure volume (taken while a force was being applied to the valve member and/or while a pressurised fluid was leaking out of the control pressure volume) may also be used when determining the operating characteristics of the pressure actuated regulator.

Thus preferably the method of determining the operating characteristics of the pressure actuated regulator comprises using the measurements representative of the temperature in the control pressure volume (e.g. taken) while the force was being applied to the valve member (e.g. when determining the maximum and minimum positions of the valve member, and the friction acting on the valve member) and/or while the pressurised fluid was leaking out of the control pressure volume (e.g. when determining the leakage out of the control pressure volume).

The minimum and maximum positions of the valve member may be determined, using measurements representative of the pressure (and, e.g., temperature) of fluid in the control pressure volume and of the mass flow rate of fluid into the control pressure volume, taken while the force was being applied to the valve member (e.g. while the control pressure volume was being pressurised), in any suitable and desired way. In a preferred embodiment the minimum and maximum positions of the valve member are determined by determining the minimum and maximum volumes of the control pressure volume, and/or a leakage function of the control pressure volume. Preferably the minimum and maximum volumes of the control pressure volume are determined by determining a leakage function of the control pressure volume and/or using the measurements representative of the pressure (and, e.g., temperature) of fluid in the control pressure volume and of the mass flow rate of fluid into the control pressure volume, taken while the force was being applied to the valve member (e.g. while the control pressure volume was being pressurised) and the valve member was in its minimum and maximum positions.

Preferably the leakage function is determined using the measurements taken while the pressurised fluid was leaking out of the control pressure volume. Preferably the minimum volume of the control pressure volume is determined using the measurements taken while the force was being applied to the valve member before the valve member started to move (e.g. when the valve member was in its minimum position). Preferably the maximum volume of the control pressure volume is determined using the measurements taken while the force was being applied to the valve member after the control pressure volume had reached its maximum volume (e.g. when the valve member was in its maximum position).

The leakage out of the control pressure volume, may be determined, using measurements representative of the pressure (and, e.g., temperature) of fluid in the control pressure volume taken while the pressurised fluid was leaking out of the control pressure volume, in any suitable and desired way. In a preferred embodiment the leakage is determined by determining the effective leakage area, e.g. as a function of the pressure ratio across the seal of the control pressure volume, e.g. using the isentropic 1D compressible flow equation through a restriction. In other embodiments the leakage may be determined using an incompressible flow equation.

The friction on the valve member may be determined, using measurements representative of the pressure (and, e.g., temperature) of fluid in the control pressure volume taken while the force was being applied to the valve member, in any suitable and desired way. In a preferred embodiment the friction is determined by determining (e.g. an estimate of) the displacement of the valve member, e.g. as a function of time (e.g. during the period while the force was being applied to the valve member and before the valve member started to move, as well as while the valve member was moving between its minimum and maximum positions), and by using the mass flow rate of fluid into the control pressure volume while the force was being applied to the valve member. Preferably the displacement of the valve member is determined by using the mass flow rate of fluid into the control pressure volume while the control pressure volume is being pressurised. When the pressure actuated regulator comprises a biasing member (e.g. a spring in the control pressure volume), preferably the step of determining the friction on the valve member takes into account the biasing (e.g. spring) force of the biasing member.

As indicated above, a plurality of measurements representative of the pressure (and, e.g., temperature) of fluid in the control pressure volume and of the mass flow rate of fluid into the control pressure volume, taken while the force is being applied to the valve member, may be taken at a plurality of different rates of pressurisation. This may therefore enable the friction to be determined as a function of the velocity of the valve member.

Once the various operating characteristics of the pressure actuated regulator have been determined, preferably the operating characteristics (i.e. the maximum and minimum positions of the valve member, the leakage out of the control pressure volume and the friction on the valve member) are output. The operating characteristics may simply be presented, e.g. in the form of a report and/or one or more graphs, but preferably the operating characteristics are each compared against nominal expected values for the respective operating characteristic. This enables it to be determined if the pressure actuated regulator is operating normally or if there may be a fault with the regulator.

Preferably each of the nominal expected values of the operating characteristics has associated with it a respective tolerance. When one or more of the determined operating characteristics is determined to be outside of the tolerance of its respective nominal expected value, preferably the method comprises flagging the anomalous operating characteristic, i.e. to indicate that there may be something wrong with the pressure actuated regulator (or at least that something needs investigating).

As indicated above, preferably the method of determining the operating characteristics of the pressure actuated regulator is performed using a suitable data processor. The data processor may form part of the apparatus that takes the various measurements of the pressure actuated regulator, or the data processor may form part of a separate device, e.g. a portable computing unit that performs the method of determining the operating characteristics of the pressure actuated regulator at the site of the regulator or a computer that performs the method remotely from the regulator.

Certain preferred embodiments of the invention will now be described, by way of example only, with reference to the accompanying drawings in which:

FIGS. 1a and 1b show examples of pressure actuated regulators that embodiments of the present invention may be used with;

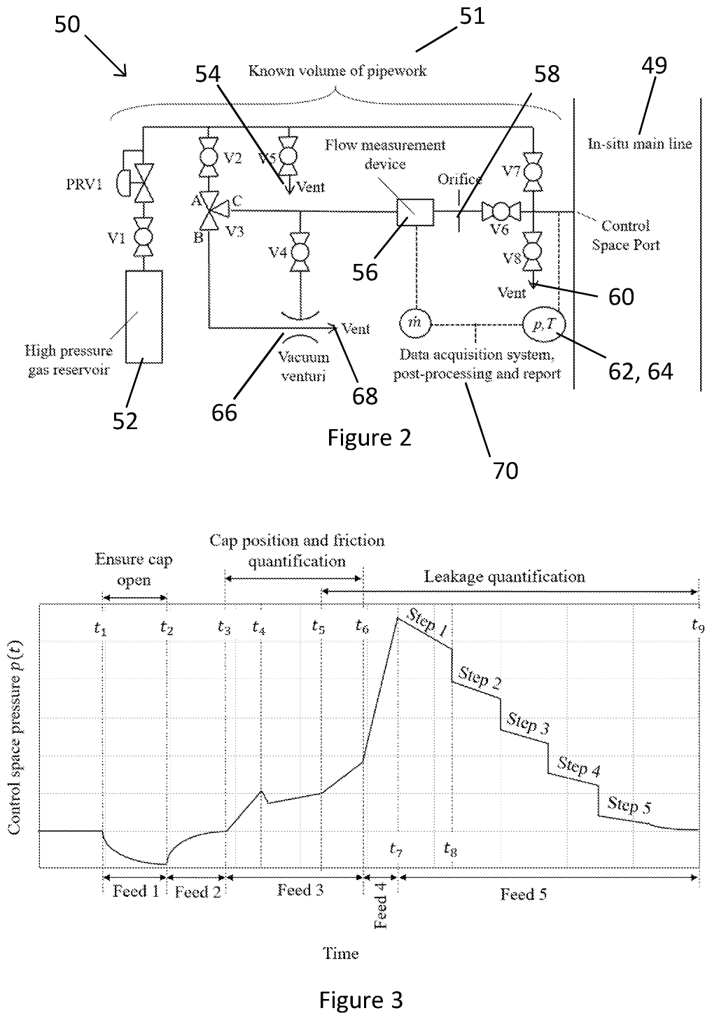

FIG. 2 shows schematically an apparatus according to an embodiment of the present invention used for functionally testing pressure actuated regulators;

FIG. 3 shows a graph of an example control pressure trace during a test procedure according to an embodiment of the present invention;

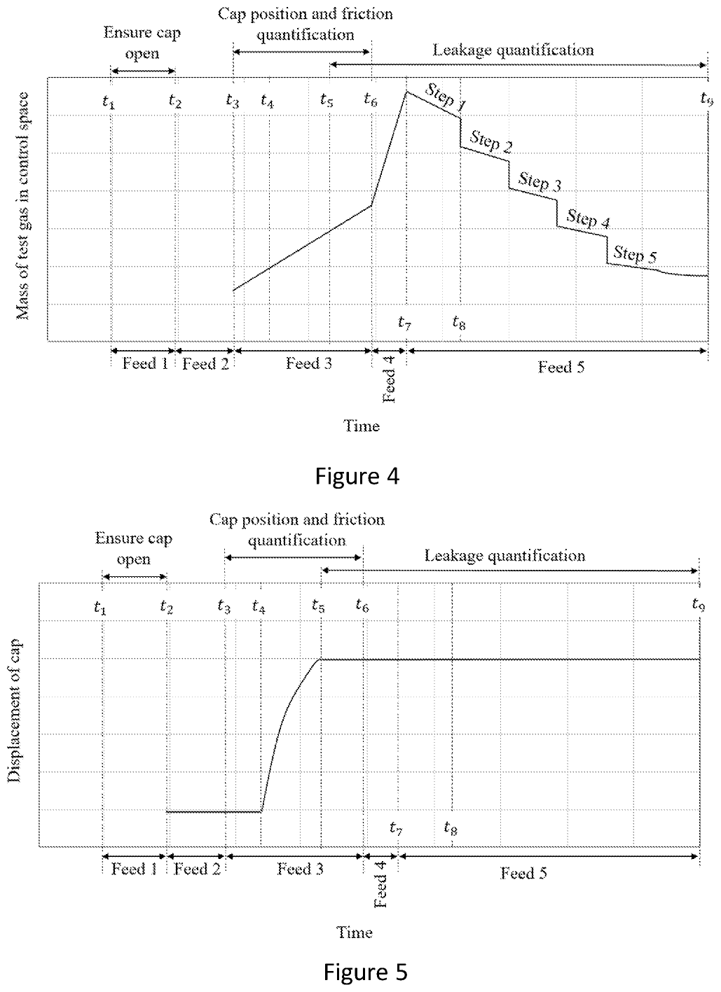

FIG. 4 shows a graph of an example mass in control pressure volume trace during a test procedure according to an embodiment of the present invention;

FIG. 5 shows a graph of an example valve member displacement trace during a test procedure according to an embodiment of the present invention;

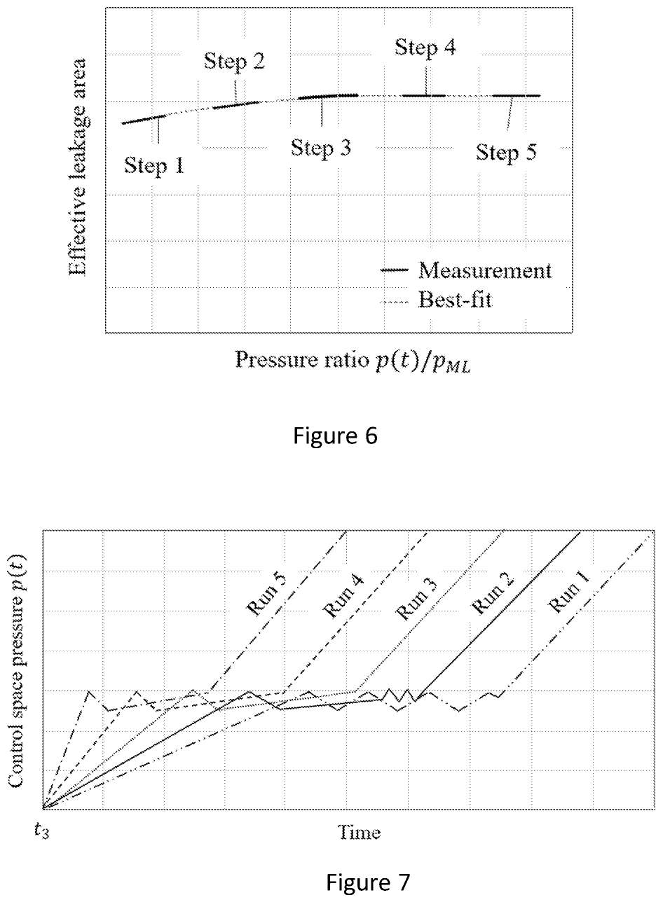

FIG. 6 shows a graph of an example effective leakage area against pressure ratio across a seal of a pressure regulator during a test procedure according to an embodiment of the present invention;

FIG. 7 shows a graph of example control pressure traces against time during a test procedure according to an embodiment of the present invention;

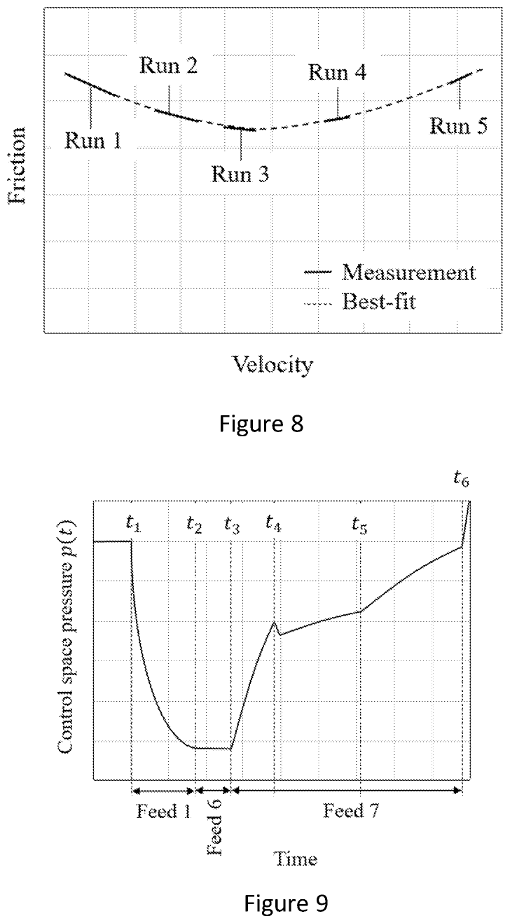

FIG. 8 shows a graph of an example friction against velocity of a valve member of a pressure regulator during a test procedure according to an embodiment of the present invention; and

FIG. 9 shows a graph of an example control pressure trace during a test procedure according to an embodiment of the present invention.

The present invention provides a method of and an apparatus for functionally testing a pressure actuated regulator, e.g. a pressure actuated regulator 10 as shown in FIG. 1a or FIG. 1b.

FIG. 2 shows schematically an apparatus 50 according to an embodiment of the present invention used for the functional testing of pressure actuated regulators, e.g. such as those shown in FIGS. 1a and 1b. The test apparatus 50 is arranged to be attached to the control pressure volume 24 (the “control space” as shown in FIGS. 1a and 1b) of a pressure actuated regulator 10 via a control port 26 that is fluidly connected to the control pressure volume 24 (e.g. the port 26 to which a pilot regulator (not shown) is attached during normal operation of the pressure actuated regulator 10 to set the control pressure in the control pressure volume 24). Thus, when using the test apparatus 50 shown in FIG. 2, the pilot regulator will generally be disconnected first from the control port 26. As can be seen from FIG. 2, the test apparatus 50 is housed in a known volume of pipework 51 and the pressure actuated regulator 10 being tested is in-situ in a main fluid flow line 49 through the side of which the control port 26 passes.

The test apparatus 50 includes a high pressure gas reservoir 52 (e.g. a cylinder of nitrogen gas), a first isolation valve V1 connected downstream of the high pressure gas reservoir 52, a pressure regulator PRV1 connected downstream of the first isolation valve V1, with the pressure regulator PRV1 being connected to the control port 26 of the pressure actuated regulator 10 being tested via another isolation valve V7. Two other isolation valves V2, V5 branch off the line between the pressure regulator PRV1 and the isolation valve V7; one of these isolation valves V2 is connected to a Tee valve V3 and the other isolation valve V5 is connected to a vent 54. The isolation valve V5 connected to the vent 54 is primarily for safety to allow for redundant venting of the test apparatus 50 when necessary.

The test apparatus 50 also includes a flow measurement device 56 (for measuring the flow rate \dot{m}(t) into the control pressure volume 24 of the pressure actuated regulator 10 being tested) connected between the Tee valve V3 and the control port 26 (and the other side of the isolation valve V7) via an orifice 58 for generating a choked flow of fluid and a further isolation valve V6. Another isolation valve V8 is connected between a vent 60 and crossing point of the lines between the isolation valves V6, V7 and the control port 26. The flow measurement device 56 is positioned to ensure optimum operation, e.g. long undisturbed pipe lengths (e.g. 20 pipe diameters) upstream and downstream of the flow measurement device.

The test apparatus 50 further includes a pressure transducer (p) 62 and a temperature transducer (T) 64 which take measurements for measuring pressure and temperature respectively from the line directly connected to the control port 26. The pressure and temperature transducers 62, 64 are positioned as close to the control port 26 as possible (to allow them to sense, as accurately as possible, the pressure and temperature of the control pressure volume 24).

A vacuum venturi 66 for generating a vacuum is connected to the other side of the Tee valve V3 from the isolation valve V2, and a further isolation valve V4 is connected between the side of the vacuum venturi 66 and the line between the Tee valve V3 and the flow measurement device 56. A vent 68 is provided on the other side of the vacuum venturi 66.

The isolation valves V1, V2, V4, V5, V6, V7, V8 and the Tee valve V3, can be controlled to open (and thus connect) or isolate different parts of the test apparatus 50 during operation, e.g. to perform different tests of the pressure actuated regulator 10 as will be described.

The (e.g. pressure, temperature and flow rate) measurements generated by the test apparatus 50 are collected and sent to a data acquisition system 70 which performs post-processing on the collected measurements to produce a report for the pressure actuated regulator 10. The data acquisition system 70 may be connected (e.g. wired or wirelessly) to the test apparatus 50 or it may be remote from the test apparatus 50.

Operation of the test apparatus 50 will now be described with reference to FIG. 2 and to FIGS. 3 to 5. FIGS. 3 to 5 show graphs of an example control pressure, an example mass in control pressure volume trace and an example valve member displacement trace respectively, taken during a test procedure according to an embodiment of the present invention.

First the test apparatus 50 is connected to the control port 26 of a pressure actuated regulator 10 (e.g. those as shown in FIGS. 1a and 1b), e.g. after the normal external control system (e.g. pilot regulator) that is normally connected to the pressure actuated regulator 10 has been disconnected and removed (after checking it is safe to do so). The test apparatus 50 is used to perform functional testing of a pressure actuated regulator. The functional testing is performed by opening and closing different combinations of the isolation valves V1, V2, V4, V5, V6, V7, V8 and the Tee valve V3, and setting different pressures using the pressure regulator PRV1.

Five general feed arrangements (i.e. combinations of valve states) are used, as shown in Table 1.

TABLE 1
Feed arrangements for the test apparatus.

| | | Valve | | | | | | | |
|---|---|---|---|---|---|---|---|---|---|
| | | V1 | V2 | V3 | V4 | V5 | V6 | V7 | V8 |
| Feed | 1 | Open | Open | AB | Open | Closed | Open | Closed | Closed |
| arrangement | 2 | Open | Closed | n/a | Open | Open | Open | Closed | Open |
| | 3 | Open | Open | AC | Closed | Closed | Open | Closed | Closed |
| | 4 | Open | Closed | n/a | Closed | Closed | Closed | Open | Closed |
| | 5 | Closed | Closed | n/a | Closed | Closed | Closed | Closed | Intermittently |
| | | | | | | | | | opened |

At the beginning of the test (in the time period t₁-t₂), the control pressure volume 24 is de-pressurised using the vacuum line (i.e. through the vacuum venturi 66) of the test apparatus 50 (using feed arrangement 1, Table 1) which sucks the valve member 14 of the pressure actuated regulator 10 into the nominally fully-closed position. The vacuum line of the test apparatus 50 is then disconnected from the control pressure volume 24 (using feed arrangement 2 during the subsequent time period t₂-t₃) and the control pressure volume 24 is slowly pressurised using the high-pressure line of the test apparatus 50 (in the time periods t₃-t₆), using feed arrangement 3.

During this time period, the flow rate into the control pressure volume 24 is maintained at a constant rate by choking the flow through the orifice 58, with this rate at which the control pressure volume 24 is pressurised being set by the pressure regulator PRV1. In the initial pressurisation phase (t₃-t₄) the control pressure volume 24 is being pressurised but the valve member 14 is yet to move; in the second phase (t₄-t₅) the valve member 14 is moving; in the third phase (t₅-t₆) the valve member 14 is in the fully open position. It is during these phases (t₃-t₆) that measurements (e.g. of the pressure, the temperature of the control pressure volume 24 and of the mass flow rate into the control pressure volume 24) are taken which allow the position of the valve member 14, and the friction between the valve member 14 and the stationary parts of the pressure actuated regulator 10 to be quantified.

The next period of the testing (t₆-t₉) is to quantify the leakage mass flow rate through the seal 28 of the pressure actuated regulator 10 at various pressure ratios. In the first part of the time period (t₆-t₇) the control space is quickly pressurised to the maximum rated pressure of the pressure actuated regulator 10 or the maximum pressure available to be delivered by the test apparatus 50 (whichever is smaller) using the high-pressure line (i.e. from the high pressure gas reservoir 52) and feed arrangement 4. The control pressure volume 24 is then isolated from the test apparatus 50 by closing all the isolation valves V6, V7, V8 around the control pressure volume 24 (feed arrangement 5). After an initial settling period, the pressure in the control space decays due to leakage.

After a period of time (e.g. hundreds of seconds (t₇-t₈)) a fraction of the pressure in the control pressure volume 24 is vented back out through one of the vents 60 in the test apparatus 50 at time t₈, by opening the isolation valve V8 temporarily. Once the pressure in the control pressure volume 24 has been reduced, the isolation valve V8 is closed again. The system is then allowed to settle, with the pressure decaying again due to leakage (during the period of time t₈ onwards).

This procedure of venting, settling and decaying is repeated several times until the control pressure volume 24 returns to ambient pressure (t₉), shown as steps 1-5 in FIG. 3. This allows the leakage flow capacity of the pressure actuated regulator 10 to be calculated at several control space pressures while maintaining a reasonably short test time. In this embodiment, leakage is measured at five control space pressures (in other embodiments, this could be any number or, if time allows, the control space could be allowed to leak until empty without intermittent venting to find leakage across a continuous range of control space pressures).

The pressure history p(t) and temperature history T(t) of the control space, and flow rate \dot{m}(t) into the control pressure volume 24, is continuously recorded throughout the entire test procedure using the pressure and temperature transducers 62, 64, and the flow measurement device 56 respectively (with no mass flow rate measurements being taken during the leakage part of the test). Examples of the data taken (or calculated from) during a test procedure using the test apparatus shown in FIG. 2, when attached to a pressure actuated regulator 10 such as shown in FIG. 1a or 1b, are shown in FIGS. 3-5.

FIG. 3 shows a graph of an example control space pressure trace during the test procedure outlined above, using the different feed arrangements outlined (referred to as Feeds 1-5; see Table 1). FIG. 4 shows a graph of the trace of the mass in the control pressure volume 24 during the test procedure, estimated from the measurements taken during the test procedure. FIG. 5 shows a graph of an example cap displacement trace during the test procedure, estimated from the measurements taken during the test procedure.

After the test is complete, the external test apparatus 50 is removed from the control port 26 and the normal external control system (e.g. pilot regulator) is reconnected. Once all the data has been collected, the performance characteristics of the pressure actuated regulator 10 being tested (e.g. verification of the fully open and the fully closed positions of the valve member 14, the integrity of the seal of the control pressure volume 24, and the static and the dynamic friction of the valve member 14) can then be determined.

In one embodiment in accordance with the invention, a leakage function β(t) is calculated between times t₇>t>t₉, defined as:

$$β ( t ) = \frac{1}{R \sqrt{T ( t )}} ( \frac{1}{T ( t )} \frac{d T ( t )}{dt} - \frac{1}{p ( t )} \frac{d p ( t )}{d t} ) , {t}_{7} > t > {t}_{9} \qquad ( 1 )$$

where T(t) is the temperature measurement as a function of time (as measured by the temperature transducer 64), p(t) is the pressure measurement as a function of time (as measured by the pressure transducer 62), and R is the specific gas constant of the gas used by the test apparatus 50 in the test procedure. (Here and elsewhere, the temperature and pressure differentials may be merged into a single term,

$$\frac{d}{dt} ( p ( t ) T ( t ) ) ,$$

e.g. giving

$$β ( t ) = \frac{\sqrt{T ( t )}}{R p ( t )} \frac{d}{dt} ( \frac{p ( t )}{T ( t )} ) . )$$

The leakage function β(t) is then interpolated as a function of the pressure ratio across the seal p(t)/p_{ML}, i.e., β(p(t)/p_{ML}) where p_{ML} is the mainline pressure (this may be chosen to be any suitable pressure but will generally be equal to atmospheric pressure during the test procedure).

The maximum volume (Vₘₐₓ) of the control pressure volume 24 (the volume of everything downstream of the flow measurement device 56) when the valve member 14 of the pressure actuated regulator 10 is in the fully open position is calculated using the mass flow rate measurement \dot{m}(t) (as measured by the flow measurement device 56), the temperature measurement T(t) (as measured by the temperature transducer 64) and the pressure measurement p(t) (as measured by the pressure transducer 62) between times t₅ and t₆:

$${V}_{max} = \frac{\dot{m} ( t ) R T ( t )}{\frac{dp ( t )}{dt} - \frac{p ( t )}{T ( t )} \frac{d T ( t )}{d t} + R p ( t ) \sqrt{T ( t )} β ( \frac{p ( t )}{{p}_{M L}} )} , {t}_{5} > t > {t}_{6} . \qquad ( 2 )$$

The maximum volume (Vₘₐₓ) may be determined through a least squares regression method, or using the average result between times t₅ and t₆, or any other suitable statistical method, for example.

Similarly, the minimum volume (Vₘᵢₙ) of the control pressure volume 24 (the volume of everything downstream of the flow measurement device 56) when the valve member 14 of the pressure actuated regulator 10 is in the fully closed position is calculated using the equivalent measurements of the mass flow rate measurement \dot{m}(t) (as measured by the flow measurement device 56), the temperature measurement T(t) (as measured by the temperature transducer 64) and the pressure measurement p(t) (as measured by the pressure transducer 62) between times t₃ and t₄:

$${V}_{min} = \frac{\dot{m} ( t ) R T ( t )}{\frac{dp ( t )}{dt} - \frac{p ( t )}{T ( t )} \frac{d T ( t )}{dt} + R p ( t ) \sqrt{T ( t )} β ( \frac{p ( t )}{{p}_{M L}} )} , {t}_{3} > t > {t}_{4} . \qquad ( 3 )$$

Again, the minimum volume (Vₘᵢₙ) may be found through a least squares regression method, or using the average result between times t₃ and t₄, or any other suitable statistical method, for example.

The maximum and minimum volumes calculated are converted into displacement positions of the valve member 14 of the pressure actuated regulator 10 using:

$$\begin{matrix}{x}_{min} = \frac{1}{A} ( {V}_{min} - {V}_{min , ideal} ) and & ( 4 ) \\ {x}_{max} = \frac{1}{A} ( {V}_{max} - {V}_{min , ideal} ) & ( 5 )\end{matrix}$$

where xₘᵢₙ is the valve member displacement when in the fully closed position (and should ideally be zero), xₘₐₓ is the valve member displacement when in the fully open position, A is the internal area within the control pressure volume 24 resolved in the direction of valve member movement over which a differential pressure acts, V_{min,ideal} is the volume between the flow measurement device 56 and the control pressure volume 24 in the ideal fully closed position, which is estimated separately (e.g. through CAD, fitting specifications and/or calibration).

The leakage of pressure from the control pressure volume 24 of the pressure actuated regulator 10 is quantified in terms of an effective leakage area Aₗₑₐₖ as a function of the pressure ratio across the seal p(t)/p_{ML}, which is based on the isentropic 1D compressible flow equation through a restriction:

$${A}_{l e a k} ( \frac{p ( t )}{{p}_{M L}} ) = \frac{β ( \frac{p ( t )}{{p}_{M L}} ) {V}_{max .}}{{( \frac{p ( t )}{{p}_{M L}} )}^{- \frac{γ + 1}{2 γ}} \sqrt{\frac{2 γ}{R ( γ - 1 )} [ {( \frac{p ( t )}{{p}_{M L}} )}^{\frac{γ - 1}{γ}} - 1 ]}} \qquad ( 6 )$$

where γ is the ratio of specific heats of the test fluid. The advantage of presenting the leakage as an effective leakage area is that it is nominally independent of the type of fluid being used, and therefore the test fluid need not be the same as the fluid used when the pressure actuated regulator 10 is operating normally.

The maximum and minimum displacements of the valve member 14 may then be presented (e.g. to the owner of the pressure actuated regulator), either in absolute terms, as a percentage of the ideal value, or in a converted quality scale (e.g. between 0 and 1, depending on how close the measured results are to the ideal values).

The leakage result may be shown graphically to be presented (e.g. to the owner of the pressure actuated regulator). FIG. 6 shows a graph of an example effective leakage area against pressure ratio across a seal 28 of a pressure regulator 10 during a test procedure according to an embodiment of the present invention.

In other embodiments, the effective leakage area may be calculated differently (e.g., using an incompressible flow equation rather than the compressible flow equation outlined in equation (6)). Furthermore, the effective leakage area may be presented differently, e.g. as a function of leakage Reynolds number, or as an average across all pressure ratios, or as a least-squares solution to the effective leakage area across the range of pressure ratios tested, or simplified as two values of the effective leakage area, e.g. the choked and unchoked effective leakage area.

The effective leakage area may also be converted into a subjective seal condition rating, e.g. as a percentage, or as a 0 or 1 value (e.g. a normalised “condition number”) to represent a binary “goodness” of the seal 28, such that it may be more easily interpreted by the user of the pressure actuated regulator 10. Thus the leakage may be presented in a number of different ways, e.g. in terms of flow rates at various pressure ratios, as a percentage of main flow, estimated as an effective leakage area from other fluid flow equations, as single values rather than distributions (e.g. as averages, least squares results or at a number of salient points), or as normalised “condition numbers”.

The position of the valve member 14 may be determined as a function of time by integrating the mass flow rate into the control pressure volume 24 to estimate the total mass of gas m(t) in the control pressure volume 24 between t₃ and t₅:

$$m ( t ) = {\int }_{{t}_{3}}^{t} ( \dot{m} ( τ ) - \frac{β ( \frac{p ( τ )}{{p}_{M L}} ) p ( τ ) {V}_{max .}}{\sqrt{T ( τ )}} ) d τ + \frac{p ( {t}_{3} ) {V}_{min .}}{R T ( {t}_{3} )} , {t}_{3} > t > {t}_{5} , \qquad ( 7 )$$

An example of this is shown in FIG. 5, which shows a graph of an example valve member displacement trace during a test procedure according to an embodiment of the present invention.

The total mass of gas in the control pressure volume 24 can then be converted into an estimate of the valve member displacement against time x(t) between t₃ and t₅:

$$x ( t ) = \frac{1}{A} ( \frac{R T ( t ) m ( t )}{p ( t )} - {V}_{min . , ideal} ) , {t}_{3} > t > {t}_{5} . \qquad ( 8 )$$

An example of this is shown in FIG. 6, which shows a graph of an example effective leakage area against pressure ratio across a seal of a pressure regulator during a test procedure according to an embodiment of the present invention.

The displacement history is used to estimate the friction on the valve member 14 as a function of time F_{friction}(t) between t₃ and t₅:

F_{friction}(t)=A(p(t)−p_{ML})−M\ddot{x}(t)−KMg,t₃>t>t₅ (9)

where M is the mass of the valve member 14, g is the gravitational constant, \ddot{x}(t) is the second temporal differential of displacement, and K depends on the orientation of the valve member 14: if the valve member 14 moves vertically and upwards through the test, K=1; if the valve member 14 moves vertically and downwards during the test, K=−1; if the valve member 14 moves horizontally, K=0. For intermediate angles, K is the resolution of the weight of the valve member 14 in the positive x direction of valve member 14 movement.

To assess the friction over a broader range of valve member 14 velocities, the portion of the testing between t₃ and t₅ may be repeated but at different rates of pressurisation to open the cap at varying velocities. In one embodiment, this is performed five times at different rates of pressurisation, though this may be more or less as required. The rate of pressurisation is set by adjusting the set pressure of PRV1.

Example pressure traces for each of these five runs are shown in FIG. 7, which shows a graph of example control pressure traces against time during a test procedure according to an embodiment of the present invention.

Depending on the velocity of the cap, the cap may undergo stick-slip motion (saw-tooth wave as seen in Runs 1 and 2). The friction is interpolated as a function of velocity F_{friction}(\dot{x}(t)) and plotted graphically. This is presented, e.g. to the owner of the pressure actuated regulator, e.g. as shown in FIG. 8 which shows a graph of an example friction against velocity of a valve member of a pressure regulator during a test procedure according to an embodiment of the present invention.

In some pressure-actuated regulators, the control pressure volume 24 may contain a biasing member (e.g. a spring) to help close the regulator 10 in no-flow conditions. In this case, the valve member position and quantification part of the test procedure starts with the control pressure volume 24 at a vacuum; and rather than filling the control pressure volume 24 using the high-pressure line of the test apparatus 50, the control pressure volume 24 is filled between t₃ and t₆ from atmosphere.

The equivalent pressure trace during a functional test for this kind of system is shown in FIG. 9, which shows a graph of an example control pressure trace during a test procedure according to an embodiment of the present invention. The combination of valves in the test apparatus 50 required to perform these tests is described in Tabl.

TABLE 2
Feed arrangements for the test apparatus, pressure-actuated regulator with spring.

| | | Valve | | | | | | | |
|---|---|---|---|---|---|---|---|---|---|
| | | V1 | V2 | V3 | V4 | V5 | V6 | V7 | V8 |
| Feed | 6 | Closed | Closed | n/a | Open | Open | Closed | Closed | Closed |
| arrangement | 7 | Closed | Open | AC | Closed | Open | Open | Closed | Closed |

Between t₁ and t₂, the control pressure volume 24 is connected to the vacuum line as described above. At the end of de-pressurisation, the control pressure volume 24 is isolated from the external test apparatus 50 and the pressures and temperatures are allowed to settle (feed 6). A vent path is then opened, in this case through V6, the orifice 58, the flow measurement device 56, the Tee valve V3 and two isolation valves V2, V5 (feed 7).

In other embodiments, this may be performed using a different arrangement of valves, but in general the flow should pass through a restriction and a flow measurement device 56 (these parts may be combined) before exhausting to atmosphere. The rate of pressurisation is controlled using the orifice 58, which may be a variable restriction such as a needle valve. The size of the restriction may be chosen according to the considerations mentioned above.

The leakage quantification is performed using the same method as described previously for the system without a spring.

Post-processing and reporting is performed using equations (1)-(8). The dynamic model of the system (equation (9)) is modified to account for the additional bias (e.g. spring) force:

F_{friction}(t)=A(p(t)−p_{ML})−M\ddot{x}(t)−KMg−kx(t)+F_{preload},t₃>t>t₅ (10)

where k is the spring constant, and F_{preload} is the force on the cap from the spring, when the regulator is fully open.

It can be seen from the above that in at least the preferred embodiments of the invention, the methods and test apparatus of the present invention allow a pressure actuated regulator to be tested functionally using the test apparatus and for one or more operating characteristics to be assessed. This helps to provide a simple and repeatable test procedure to be performed on a pressure actuated regulator such that it can be checked how well the pressure actuated regulator is performing (e.g. a “health check”).

Owing, in at least preferred embodiments, to the test procedure only manipulating the control pressure volume of a pressure actuated regulator, this may not involve passing fluid through the regulator itself. Thus the method may be performed and the apparatus used on the pressure actuated regulator non-intrusively, e.g. without breaking open or pressurising the main line of the pipe or conduit in which the pressure actuated regulator is positioned.

It will be appreciated that the measurements taken and the data produced, as described above, may be analysed anywhere and by any suitable data processor. Furthermore, smoothing algorithms may be applied to the pressure and/or temperature measurements in order to improve numerical differentiation, where appropriate. The determined operating characteristics may be presented to the owner or user of the pressure actuated regulator as outlined above; however, in addition intermediate steps of testing (e.g. displacement, pressure, temperature and/or mass flow rate histories) may be presented.

1. A method of functionally testing a pressure actuated regulator, wherein the pressure actuated regulator comprises a valve member arranged to open and close one or more valve apertures, and a control pressure volume in which a control pressure is set to act on the valve member, the method comprising:
applying a force to the valve member, and taking measurements representative of a pressure of a fluid in the control pressure volume and of a mass flow rate of the fluid into the control pressure volume while the force is being applied to the valve member;
isolating the control pressure volume and allowing a pressurized fluid in the control pressure volume to leak out of the control pressure volume, and taking measurements representative of a pressure of the pressurized fluid in the control pressure volume while the pressurized fluid leaks out of the control pressure volume; and
communicating and/or storing, for assessing one or more operating characteristics of the pressure actuated regulator, the measurements taken representative of the pressure of fluid in the control pressure volume and of the mass flow rate of the fluid into the control pressure volume while the force was being applied to the valve member, and the measurements taken representative of the pressure of the pressurized fluid in the control pressure volume while the pressurized fluid was leaking out of the control pressure volume.

2. The method as claimed in claim 1, comprising depressurizing the control pressure volume before the force is applied to the valve member.

3. The method as claimed in claim 1, wherein the pressure actuated regulator comprises a biasing member arranged to apply a force to the valve member, wherein applying the force to the valve member comprises allowing the biasing member to move the valve member to increase the volume of the control pressure volume while the control pressure volume is filled from atmosphere.

4. The method as claimed in claim 1, wherein the step of applying the force to the valve member comprises pressurizing the control pressure volume.

5. (canceled)

6. The method as claimed in claim 1, wherein the force is applied to the valve member at least until the control pressure volume reaches a maximum volume.

7. The method as claimed in claim 1, wherein the pressurized fluid in the control pressure volume is allowed to leak out of the control pressure volume while the valve member is in its open position.

8. The method as claimed in claim 1, comprising venting the control pressure volume after the pressurized fluid in the control pressure volume has been leaking out of the control pressure volume for a period of time, isolating the control pressure volume, allowing the pressurized fluid in the control pressure volume to leak out of the control pressure volume after the control pressure volume has been vented, and taking measurements representative of the pressure of the pressurized fluid in the control pressure volume while the pressurized fluid leaks out of the control pressure volume.

9. The method as claimed in claim 1, comprising taking a measurement representative of a temperature of fluid in the control pressure volume while the control pressure volume is being pressurized and while the pressurized fluid is allowed to leak out of the control pressure volume.

10. The method as claimed in claim 1, wherein the one or more operating characteristics of the pressure actuated regulator that are determined include one or more of: the maximum and minimum positions of the valve member, the leakage out of the control pressure volume, and the friction of the valve member.

11. A method of determining a plurality of operating characteristics of a pressure actuated regulator, wherein the pressure actuated regulator comprises a valve member arranged to open and close one or more valve apertures, and a control pressure volume in which a control pressure is set to act on the valve member, the method comprising:
determining the maximum and minimum positions of the valve member, using measurements representative of a pressure of a fluid in the control pressure volume and of a mass flow rate of the fluid into the control pressure volume taken while a force was being applied to the valve member;
determining the leakage out of the control pressure volume, using measurements representative of the pressure of a fluid in the control pressure volume taken while a pressurized fluid was leaking out of the control pressure volume; and
determining the friction on the valve member, using measurements representative of the pressure of the fluid in the control pressure volume and of the mass flow rate of the fluid into the control pressure volume taken while the force was being applied to the valve member.

12. The method as claimed in claim 11, wherein the minimum and maximum positions of the valve member are determined by determining the minimum and maximum volumes of the control pressure volume, and/or a leakage function of the control pressure volume.

13. (canceled)

14. The method as claimed in claim 11, wherein the friction is determined by determining a displacement of the valve member, and/or by using the measurement representative of the pressure in the control pressure volume while the force was being applied to the valve member.

15. An apparatus for functionally testing a pressure actuated regulator, wherein the pressure actuated regulator comprises a valve member arranged to open and close one or more valve apertures, and a control pressure volume in which a control pressure is set to act on the valve member, the apparatus comprising:
one or more isolation valves for isolating the control pressure volume;
a pressure sensor for measuring a pressure representative of the pressure of fluid in the control pressure volume;
a flow rate sensor for measuring a mass flow rate of fluid into the control pressure volume; and
a communication subsystem and/or a data storage for communicating and/or storing the measurements representative of the pressure and temperature of fluid in the control pressure volume;
wherein the apparatus is configured to:
take measurements representative of the pressure of fluid in the control pressure volume using the pressure sensor and of the mass flow rate of fluid into the control pressure volume using the flow rate sensor while a force is being applied to the valve member;
close the one or more isolation valves to isolate the control pressure volume;
allow a pressurized fluid in the control pressure volume to leak out of the control pressure volume, and take measurements representative of the pressure of fluid in the control pressure volume using the pressure sensor while the fluid leaks out of the control pressure volume; and
communicate and/or store, for assessing one or more operating characteristics of the pressure actuated regulator, the measurements taken representative of the pressure of fluid in the control pressure volume and of the mass flow rate of the fluid into the control pressure volume while the force was being applied to the valve member, and the measurements taken representative of the pressure of the pressurized fluid in the control pressure volume while the pressurized fluid was leaking out of the control pressure volume.

16. The apparatus as claimed in claim 15, comprising a depressurization subsystem for depressurizing the control pressure volume, wherein the apparatus is configured to depressurize the control pressure volume using the depressurization subsystem before the force is applied to the valve member.

17. The apparatus as claimed in claim 15, wherein the pressure actuated regulator comprises a biasing member arranged to apply a force to the valve member, wherein the apparatus is configured to take the measurements representative of the pressure of fluid in the control pressure volume using the pressure sensor and of the mass flow rate of fluid into the control pressure volume using the flow rate sensor while the biasing member moves the valve member to increase the volume of the control pressure volume.

18. The apparatus as claimed in claim 15, comprising a pressurization subsystem for pressurizing the control pressure volume to apply the force to the valve member, wherein the apparatus is configured to take the measurements representative of the pressure of fluid in the control pressure volume using the pressure sensor and of the mass flow rate of fluid into the control pressure volume using the flow rate sensor while the control pressure volume is being pressurized.

19. (canceled)

20. (canceled)

21. The apparatus as claimed in claim 15, wherein the apparatus is configured to allow a pressurized fluid in the control pressure volume to leak out of the control pressure volume while the valve member is in its open position.

22. The apparatus as claimed in claim 15, wherein the apparatus is configured to open the one or more isolation valves to vent the control pressure volume after the fluid in the control pressure volume has been leaking out of the control pressure volume for a period of time, close the one or more isolation valves to isolate the control pressure volume again, allow the pressurized fluid in the control pressure volume to leak out of the control pressure volume after the control pressure volume has been vented, and take measurements representative of the pressure of the pressurized fluid in the control pressure volume using the pressure sensor while the pressurized fluid leaks out of the control pressure volume.

23. The apparatus as claimed in claim 15, comprising a temperature sensor for measuring a temperature representative of the temperature of fluid in the control pressure volume, wherein the apparatus is configured to take a measurement representative of the temperature of fluid in the control pressure volume using the temperature sensor while the control pressure volume is being pressurized and while the pressurized fluid is allowed to leak out of the control pressure volume.

24. The apparatus as claimed in claim 15, wherein the apparatus is configured to determine the one or more operating characteristics of the pressure actuated regulator which include one or more of: verification of fully open and fully closed positions of the valve member, an integrity of the seal of the control pressure volume, and a static and a dynamic friction of the valve member.

25. (canceled)
